(19) United States
(12) Patent Application Publication
(10) Pub. No.: US 2014/0287303 A1
(43) Pub. Date: Sep. 25, 2014

(54) ELECTRODE AND METHOD FOR MANUFACTURING AN ELECTRODE

(71) Applicants: Silvan HIPPCHEN, Sersheim (DE); Andreas NETZ, Ludwigsburg (DE)

(72) Inventors: Silvan HIPPCHEN, Sersheim (DE); Andreas NETZ, Ludwigsburg (DE)

(73) Assignee: Robert Bosch GmbH, Stuttgart (DE)

(21) Appl. No.: 14/217,740

(22) Filed: Mar. 18, 2014

(30) Foreign Application Priority Data
Mar. 20, 2013 (DE) 10 2013 204 875.0

(51) Int. Cl. H01M 4/04; H01M 4/139; H01M 4/02

(52) U.S. Cl. CPC H01M 4/0404; H01M 4/02; H01M 4/0421; H01M 4/139; H01M 2220/30
USPC 429/209; 427/58

(57) ABSTRACT

A method for manufacturing an electrode, including: a) providing a dry active material mixture; b) providing a preformed current collector; and c) applying the dry active material mixture onto at least one subregion of the current collector to form an active material layer. A method of this kind offers a particularly cost-effective way of manufacturing an electrode in a particularly defined manner and without unrectifiable rejects. Also described is a related electrode.

### RELATED APPLICATION INFORMATION

The present application claims priority to and the benefit of German patent application no. 10 2013 204 875.0, which was filed in Germany on Mar. 20, 2013, the disclosure of which is incorporated herein by reference.

### FIELD OF THE INVENTION

The present invention relates to an electrode. The present invention further relates to a method for manufacturing an electrode.

### BACKGROUND INFORMATION

In the manufacture of electrodes such as foil-type electrodes for lithium-ion cells for example, the battery material is often applied on a current collector in the form of a suspension or a slurry. The current collector for this purpose is usually made of metal, the metal being chosen as a function of the type of electrode to be manufactured. For this purpose, the current collector may be rolled off a roll prior to coating and rolled up again after coating. Furthermore, the coated current collector foil is dried, for example by convection drying or IR drying, which allows the solvent of the slurry to be driven out. Subsequently, a calendering process is usually performed in order to set the porosity formed in the drying process for example. Subsequently, the electrode is formed.

A method for manufacturing a battery electrode is discussed in patent documents DE 10 2010 062 140 A1 and DE 10 2010 063 143 A1, for example. In a method of this kind, first a collector substrate is coated essentially in its entirety with an active material and this coated product is subsequently calendered. A method of this kind furthermore includes a removal of material for forming an arrester region and the formation of the electrode from the collector substrate by cutting out or punching out the electrode.

### SUMMARY OF THE INVENTION

The subject matter of the present invention is a method for manufacturing an electrode, including the method steps:
a) Providing a dry active material mixture;
b) Providing a preformed current collector; and
c) Applying the dry active material mixture onto at least one subregion of the current collector to form an active material layer.

A method as described above makes it possible to manufacture an electrode, it being possible essentially to preserve the advantages of methods known from the related art, while reliably avoiding disadvantages of methods known from the related art in a cost-effective type of process.

For this purpose, the method for manufacturing an electrode includes providing a dry active material mixture according to method step a). The active material mixture may have components that are known per se for a respective energy store. For the exemplary and non-limiting case of manufacturing an electrode for a lithium-ion battery, the active material for an anode may include graphite for example, which may be in a concentration greater than or equal to 94% by weight, whereas the active material for a cathode may include for example a lithium salt such as lithium nickel cobalt manganese oxide (NCM) or lithium manganese oxide (LMO), which may be in a concentration greater than or equal to 93% by weight. The active material is thus in particular a material or a substance or a substance mixture that is able to participate in active charging processes or discharging processes of an energy store. The active material mixture may furthermore include a binder such as polyvinylidene fluoride (PVDF), for example, which may be in a concentration less than or equal to 4% by weight, in which the previously described active material is distributed. Moreover, a conductive additive such as conductive carbon compounds, for example soot, may be added, which may be in a concentration less than or equal to 2% by weight.

Furthermore, the active material mixture is dry according to method step a). This means that the active material together with the other constituents, in particular as described above, is not provides as a slurry together with a solvent, as known from the related art, but rather without solvent and thus as a solid, for example as a powder. The active material mixture in particular has no liquid.

Furthermore, according to method step b), a preformed current collector is provided. Such a current collector may be developed from a material known per se. The current collector may be developed from aluminum for instance if a cathode is being manufactured, whereas the current collector may be developed from copper for instance if an anode is being manufactured.

Moreover, according to method step b), the current collector is already preformed. In the sense of the present invention, a preformed current collector may mean in particular that the current collector at this point in time, that is, essentially before being provided with an electrode material or with the active material mixture, may already have its desired, particularly final form. A subsequent cutting out or punching out or the like is thus not required.

In another method step c), the dry active material mixture is applied onto at least one subregion of the current collector to form an active material layer. In this method step, the active material mixture is thus applied onto the preformed current collector or onto defined regions of the same. This application may be performed fundamentally in any manner suitable per se for the manufacture of electrodes.

The method described above is thus based in particular on the use of a current collector that is already shaped and thus developed in particular in its final form or in its final geometry, and to coat this with the dry active material to develop an active material layer or electrode material layer. This makes it possible to avoid having to shape a current collector that is already coated with the active material, for example by cutting or punching it out. Furthermore, there is no need to dry the active material layer.

The method described above may have, inter alia, the advantages of being able to reduce or completely avoid the disadvantages or the risks entailed by a shaping process, for example cutting, of the coated current collector for later operation.

In detail, by using a preformed current collector, the method described above is able to prevent the formation of burrs by cutting or punching, which may negatively affect the later operation or the possible performance of the electrode. It is furthermore possible to prevent particles, which may detach from the active material layer in a shaping process, from triggering a short circuit in later operation in an undesired location in the cell and thus damage or destroy the latter.

The present invention rather allows for a particularly long and reliable operation of an electrode.

Furthermore, after the current collector has been coated, a sturdy electrode may be obtained, in which no mechanical stress by punching for example causes the active material layer or regions of the same to flake off, or where in laser cutting deformation occur in the edge region of the electrode or the material or the electrode composition changes as a result of high laser-related energy output. Since, as described above, such influences are undesirable in electrodes, the coated material is often cut in the related art. Such trimming may be avoided according to the present invention, however, which may lower the process costs and thus allow for a particularly cost-effective manufacture, in particular due to the high material costs within the value added chain of battery costs.

Moreover, a particularly defined development may be performed without performance-impairing negative influences, which also makes it possible to design the performance data to be particularly high and defined.

Furthermore, the use of a dry, that is, solid-like and thus solvent-free active material mixture makes it possible to produce a desired and precisely defined porosity in the active material mixture already during the application of the active material mixture on the current tap. The porosity is not changed by a drying process and thus the expulsion of a solvent from the active material layer. The porosity is thus on the one hand very defined. On the other hand, additional process steps for setting the porosity, calendering for example, may be omitted such that the method may be carried out in a particularly simple and cost-effective manner. The latter may be enhanced further in that there is no need to use solvents, which may reduce the costs further for example by saving the cost of the solvent material and omitting the drying step.

This also allows for a particularly lean process management while keeping the process control simple, which makes it possible essentially to use existing plant technology, which may be particularly reliable.

The method described above furthermore allows for a particularly pronounced homogeneity of the active material layer, the active material layer also being able to adhere particularly well to the current collector, which allows for a particularly stable, uniform and defined performance of the electrode.

In summary, the method described above makes it possible to manufacture electrodes in a particularly cost-effective and defined manner and at a high performance rating of the electrodes to be operated later.

In connection with one development, method step c) may be performed by using a propellant, in particular a propellant gas. Using a propellant in particular makes it possible to apply the dry active material mixture onto the current collector in a particularly simple and defined manner and using a readily controllable process management. A propellant gas such as the inert gas argon may be used as a propellant in this context. The porosity of the applied active material layer may be set in particular by the process parameters in using the propellant. Modifiable parameters include for example the pressure, the flow speed, the quantity of the propellant in relation to the quantity of the active material mixture. Suitable porosities include for example a range of greater than 30% of volume and/or smaller than 50% of volume, in relation to the electrode. The size of the pores may be less than 5 μm for example.

In connection with another development, the active material mixture may be fastened on the current collector by a thermal bonding of the active material with the surface of the current collector. For this purpose, the active material may be melted together with the binder and applied by the propellant gas in a finely distributed manner on the current collector. Following the application of the active material, the latter is able to cool off and thus solidify and thereby be fastened in a particularly stable manner on the surface of the current collector. Alternatively, it is also possible first to apply the active material on the current collector and melt the binder there and to fasten the active material by cooling the melt. In this development in particular, the application of the active material on the current collector may be particularly stable, which makes the manufactured electrode likewise particularly stable over the long term and makes an energy store equipped with such an electrode particularly resistant to damage. In the sense of the present invention, a thermal bonding may therefore signify in particular a fixing of the active material mixture by an application of heat.

In connection with another development, method step c) may be performed by using a mask. The use of a mask in particular allows for the application of precisely defined structures of the active material layer on the current collector by masking or covering regions of the current collector that are not to be coated. Desired and precisely defined regions may thus be exempted from a coating, which regions are not to be provided with an active material for example. Current taps or other contact regions, or regions that are to be equipped with additional components, may be exempted from being coated with active material. This development thus makes it possible to produce a particularly freely selectable electrode structure, even in the above-described method, which increases the breadth of application of the method even further. The masks may be developed from, or be made of, moldable or cuttable metal such as aluminum or stainless steel for example.

In connection with another development, the current collector may be preformed by cutting or stamping. This development makes it possible in particular to produce highly precise electrode structures, which have a particularly defined geometry. Moreover, the aforementioned methods are essentially technically mature and furthermore applicable without problems in method of manufacturing electrodes.f The advantages of these shaping method may also be maintained in the method described above, without, however, their disadvantages arising in shaping a current collector coated with active material.

In the context of one development, a current collector foil may be used as current collector. A current collector foil may have in particular a small thickness in comparison to its length and width and may be configured to be foil-like, that is, particularly flexible, for example. In particular for foil-like current collectors or for current collector foils, the method described above may be particularly suitable since in foil-like current collectors in particular, an adverse influence on the electrode structure cannot always be avoided entirely. Current collector foils in particular therefore require a gentle manufacturing method in order to be able to produce a reject-free defined structure. Non-limiting thicknesses of current collector foils, which in the case of a cathode may be developed from aluminum and in the case of an anode from copper, are for example and without being limiting in a range of greater than or equal to 5 μm and/or smaller than or equal to 50 μm.

The thickness of the current collector foils may be selected in particular as a function of the desired stability of the electrode or the stability of the active material layer as such. If the active material layer has a sufficient stability for example, then the thickness of the current collector foils may be selected to be accordingly small. If, on the contrary, the active material or the active material layer as such does not have sufficient stability, then a greater thickness of the current collector may be advantageous.

In connection with another development, a current tap may be situated on the current collector prior to method step c). This development allows for a particularly stable attachment of the current tap, which may be developed in particular from the same material as the current collector. For with respect to the attachment, no existing active material needs to be taken into account or the current tap may already be developed when the current collector is shaped. A current tap may be protected against being coated with active material by a suitable arrangement when applying the active material. For example, as described above in one specific embodiment, an existing current tap may be covered by a mask so as to prevent it from being coated with an active material. A current tap may be in particular a component attached to the current collector, which current collector merges the current flow of the electrodes, and in particular electrically connects the electrodes or the current collector to an external contact. The current collector may be furthermore developed in one piece with the current tap. The current tap may be developed as a current tap lug for example.

Regarding additional advantages and features, explicit reference is hereby made to the explanations in connection with the electrode of the present invention and the figure. Features and advantages of the method of the present invention are also to be considered applicable to the electrode of the present invention and count as disclosed, and vice versa. The present invention also includes all combinations of at least two of the features disclosed in the specification, in the claims and/or in the figure.

A subject matter of the present invention is also an electrode that is manufactured as described above. Electrodes of this kind in particular may be manufactured especially cost-effectively and have an especially defined structure. Moreover, it is particularly easy to custom-tailor electrodes of this kind so that they have a particularly wide field of application.

Regarding additional advantages and features, explicit reference is hereby made to the explanations in connection with the electrode of the present invention and the figure.

Features and advantages of the electrode of the present invention are also to be considered applicable to the method of the present invention and count as disclosed, and vice versa. The present invention also includes all combinations of at least two of the features disclosed in the specification, in the claims and/or in the figure.

Further advantages and advantageous refinements of the subject matters of the present invention are illustrated by the drawing and explained in the following description. In this context, it should be noted that the drawing has only a descriptive character and is not intended to limit the present invention in any form.

### BRIEF DESCRIPTION OF THE DRAWING

FIG. 1 shows a schematic representation of a method step of the method according to the present invention.

### DETAILED DESCRIPTION

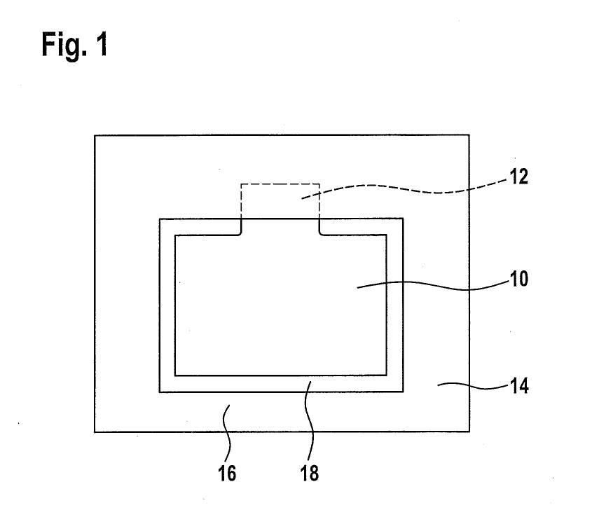

FIG. 1 shows a method step for manufacturing an electrode. FIG. 1 shows in particular a preparation of current collector 10 for being coated with a dry active material mixture. An electrode producible in this manner may be a component of a lithium-ion battery for example and may as such find application, for example, in consumer electronics as well as in electrically driven vehicles.

FIG. 1 shows that current collector 10 is provided, which may be a current collector foil for example, and which may be preformed in particular prior to the application of the active material mixture, for example by cutting or stamping. Furthermore, a current tap 12, such as a current tap lug for example, may be situated on current collector 10.

In order to protect for example current tap 12 against being coated, a mask 14 is provided, which covers current tap 12 and exposes the region of current collector 10 that is to be coated. For this purpose, the mask has a covering region 16 and an exposing region 18. In this manner, a provided dry active material mixture may now be applied on the exposed part of current collector 10 to form an active material layer.

The application may be implemented by using a propellant such as in particular a propellant gas.

What is claimed is:

1. A method for manufacturing an electrode, the method comprising:
(a) providing a dry active material mixture;
(b) providing a preformed current collector; and
(c) applying the dry active material mixture onto at least one subregion of the current collector to form an active material layer.

2. The method of claim 1, wherein task (c) is performed by using a propellant gas.

3. The method of claim 1, wherein the active material mixture is fastened on the current collector by thermal bonding of the active material mixture with the surface of the current collector.

4. The method of claim 1, wherein task (c) is performed by using a mask.

5. The method of claim 1, wherein the current collector is preformed by cutting or stamping.

6. The method of claim 1, wherein a current collector foil is used as current collector.

7. The method of claim 1, wherein prior to performing task (c), a current tap is situated on current collector.

8. An electrode, comprising:
an electrode arrangement, including a preformed current collector and an active material layer, wherein the electrode arrangement is made by performing the following:
(a) providing a dry active material mixture;
(b) providing the preformed current collector; and
(c) applying the dry active material mixture onto at least one subregion of the current collector to form the active material layer.
